(19) United States
(12) Patent Application Publication
(10) Pub. No.: US 2012/0314156 A1
(43) Pub. Date: Dec. 13, 2012

(54) ILLUMINATION DEVICE AND DISPLAY DEVICE

(75) Inventor: Shinnosuke Nozawa, Osaka-shi (JP)

(73) Assignee: SHARP KABUSHIKI KAISHA, Osaka-shi, Osaka (JP)

(21) Appl. No.: 13/511,039

(22) PCT Filed: Oct. 14, 2010
(86) PCT No.: PCT/JP2010/068003

§ 371 Date: May 21, 2012

(30) Foreign Application Priority Data
Dec. 2, 2009 (JP) 2009-274389

(51) Int. Cl. G02F 1/13357; G09F 13/04; F21V 11/00; F21V 21/00; F21V 9/08

(52) U.S. Cl. 349/58; 362/249.14; 362/231; 362/230; 362/235; 362/97.1

(57) ABSTRACT

An illumination device or the like is provided that reduces variations in the position of a member incorporating light sources such as LEDs and that reduces the size of the member and thus achieves the size reduction. In the illumination device, a plurality of mounting substrates (11) are arranged close to each other, and the mounting substrates (11) are regular hexagonal.

### TECHNICAL FIELD

The present invention relates to an illumination device that supplies light to a display panel used in a television set, digital signage or the like, and to a display device including the illumination device and the display panel.

### BACKGROUND ART

A liquid crystal display device (display device) that incorporates a non-light emission liquid crystal display panel (display panel) generally incorporates a backlight unit (illumination device) that supplies light to the liquid crystal display panel. There are various types of light sources for backlight units. For example, in a backlight unit disclosed in patent document 1, a light source is an LED (light emitting diode).

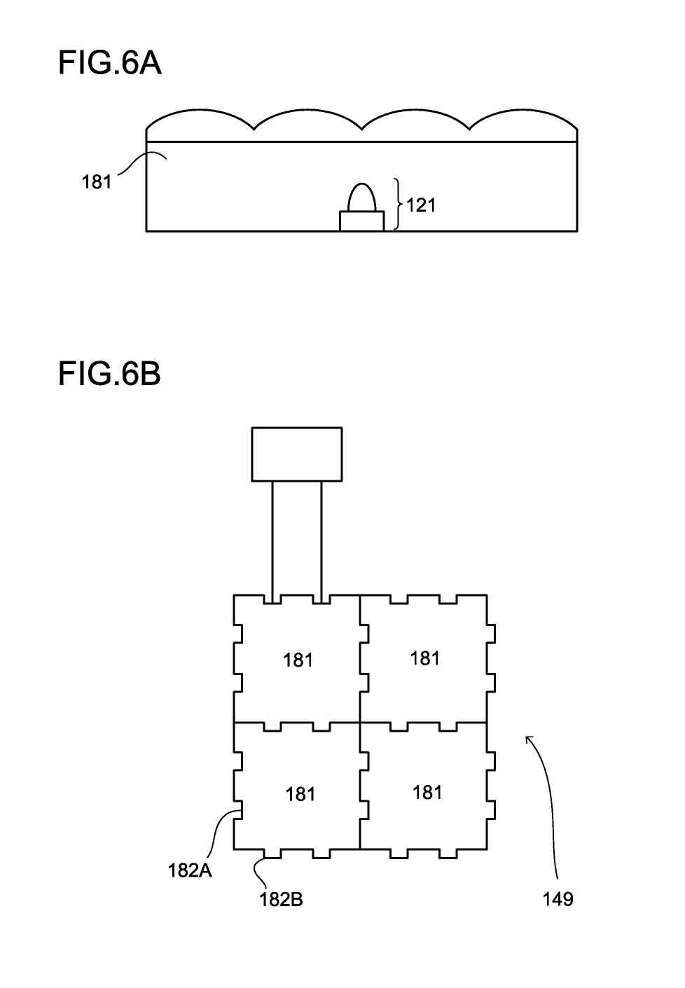

In the backlight unit disclosed in patent document 1, as shown in the cross-sectional view of FIG. 6A, a planar light source light emitting member 181 holds the LED 121. In the perimeter of the planar light source light emitting member 181, as shown in the plan view of FIG. 6B, recess portions 182A and projection portions 182B are formed. Hence, when the planar light source light emitting members 181 are adjacent to each other, the recess portions 182A and the projection portions 182B fit each other, and thus the planar light source light emitting members 181 are unlikely to be displaced from each other.

### RELATED ART DOCUMENT

### Patent Document

Patent document 1: JP-A-2009-176899

### DISCLOSURE OF THE INVENTION

### Problems to be Solved by the Invention

However, in the backlight unit 149 disclosed in patent document 1, the recess portions 182A and the projection portions 182B formed in the perimeter of the planar light source light emitting member 181 cause the size of the planar light source light emitting member 181 to be increased. Consequently, the size of the backlight unit 149 incorporating a plurality of planar light source light emitting members 181 is also increased.

The present invention is made to overcome the foregoing problem. An object of the present invention is to provide an illumination device or the like that reduces variations in the position of a member (for example, a mounting substrate on which an LED is mounted) incorporating a light source such as an LED and that decreases the size of the member and thus achieves the size reduction of the illumination device or the like.

### Means for Solving the Problem

An illumination device includes light sources and a plurality of mounting substrates having the light sources arranged. In the illumination device, the mounting substrates are arranged close to each other, and the mounting substrates are regular hexagonal.

In this configuration, the mounting substrates are arranged to have a honeycomb structure. Hence, each of the mounting substrates is unlikely to undergo variations in the position. Moreover, as a whole, the adjacent mounting substrates are shaped to engage with each other, and thus special engagement portions (for example, recesses and projections engaging with each other) are not needed in the perimeter of the mounting substrate. Therefore, since the mounting substrate does not have the special engagement portions, the size thereof is reduced accordingly.

Preferably, connectors, each including a positive terminal electrically continuous to a positive pole of one of the light sources and a negative terminal electrically continuous to a negative pole of the light source, are attached to the perimeter of one of the mounting substrates, and the terminals of like poles of the connectors in the adjacent mounting substrates are electrically continuous.

In this configuration, no matter how the mounting substrates are arranged close to and adjacently to each other, the mounting substrates are electrically continuous with the connectors of the mounting substrates.

An example of the light source is a light emitting element. As a plurality of the light emitting elements, a red light emitting element, a green light emitting element and a blue light emitting elements may be provided so as to be mixed; a plurality of the light emitting elements may be white light emitting elements.

Preferably, the illumination device includes an electric power adjustment portion that adjusts the amount of power supplied to the light sources.

Preferably, the illumination device includes a diffusion member that diffuses light from the light sources. Preferably, the illumination device includes a brightness enhancement member that enhances brightness by transmitting the light from the light sources.

A display device including the illumination device described above and a display panel (for example, a liquid crystal display panel) that receives light from the illumination device can be said to be one aspect of the present invention.

### Advantages of the Invention

According to the present invention, even if a plurality of mounting substrates are arranged in an illumination device, the mounting substrates are unlikely to be displaced from each other, and the mounting substrates as a whole are reduced in size.

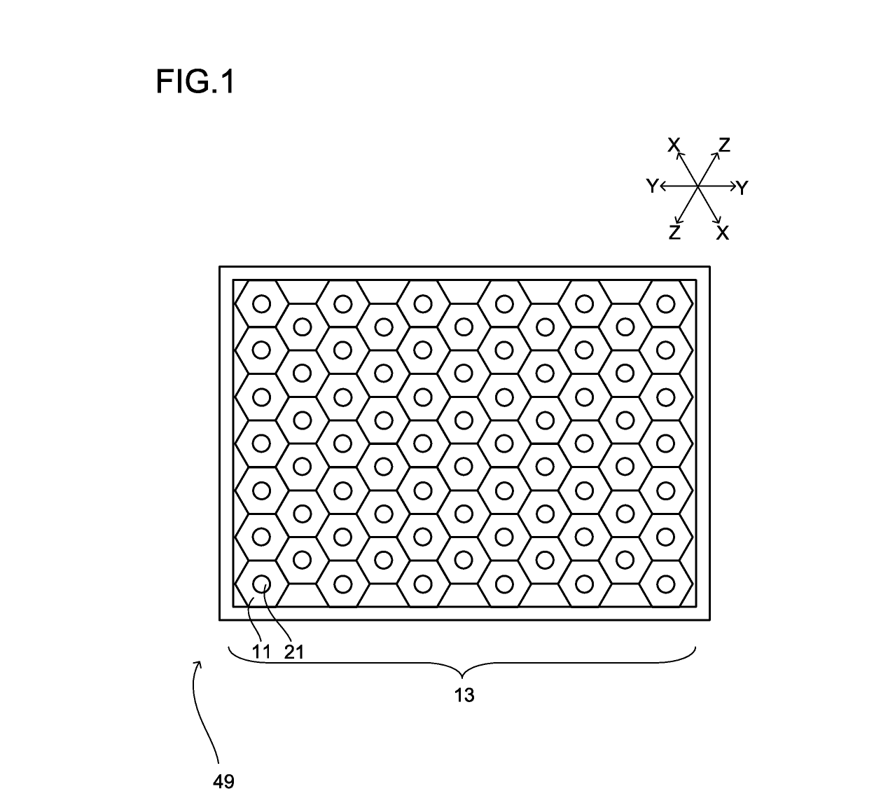

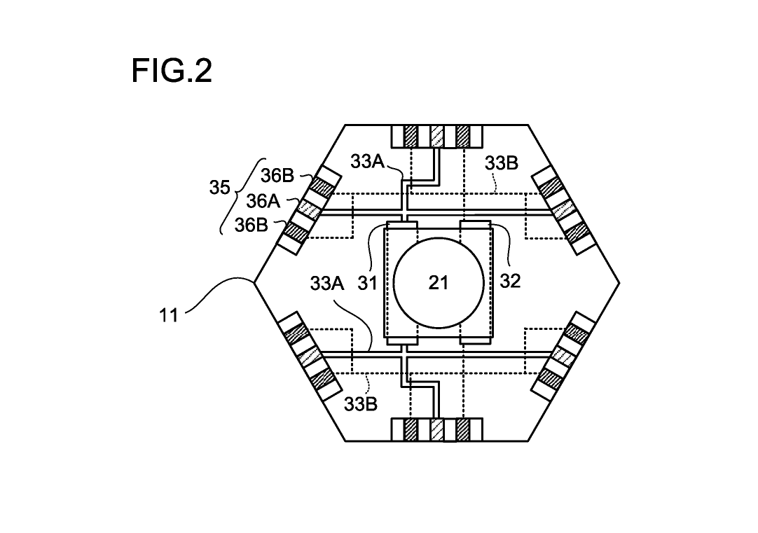

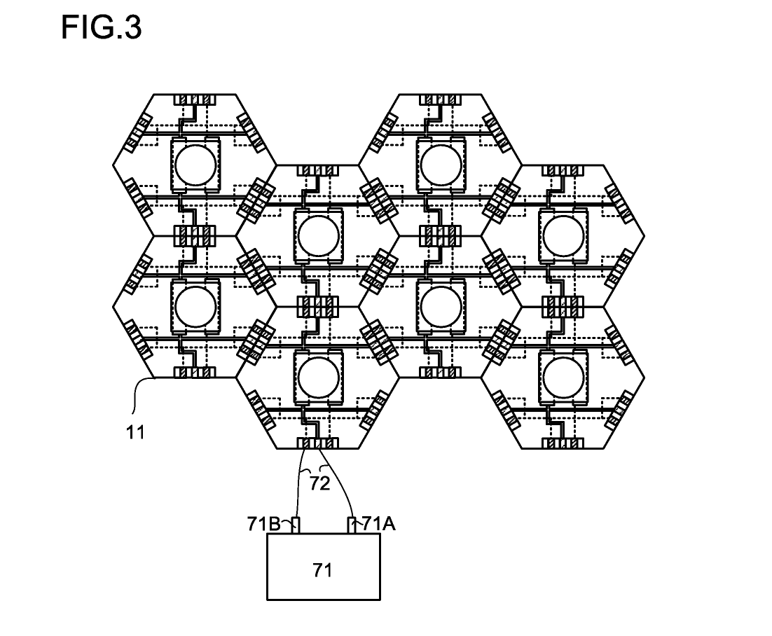

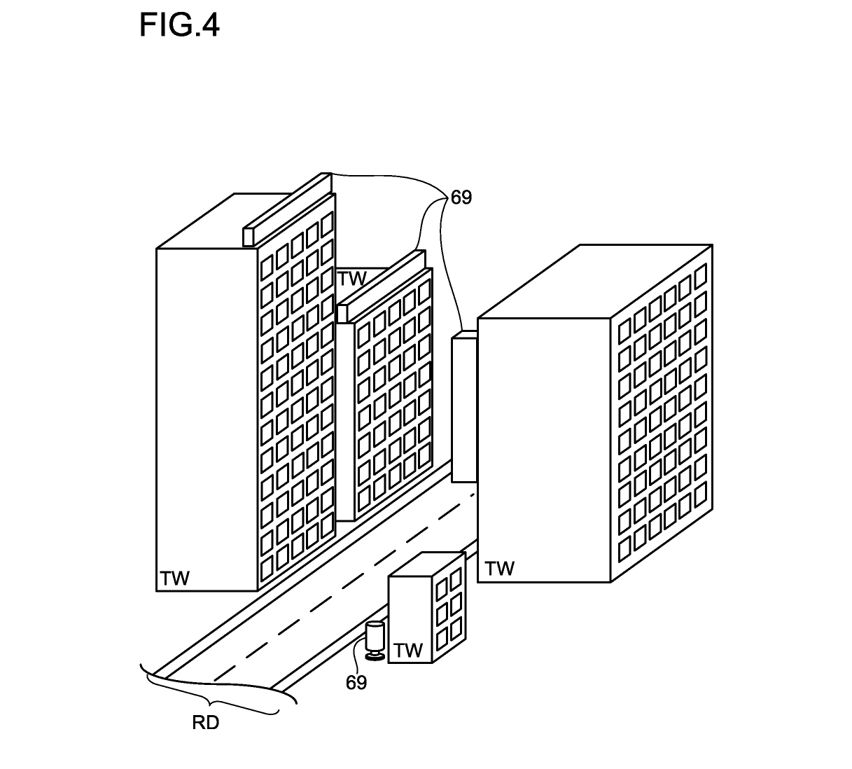

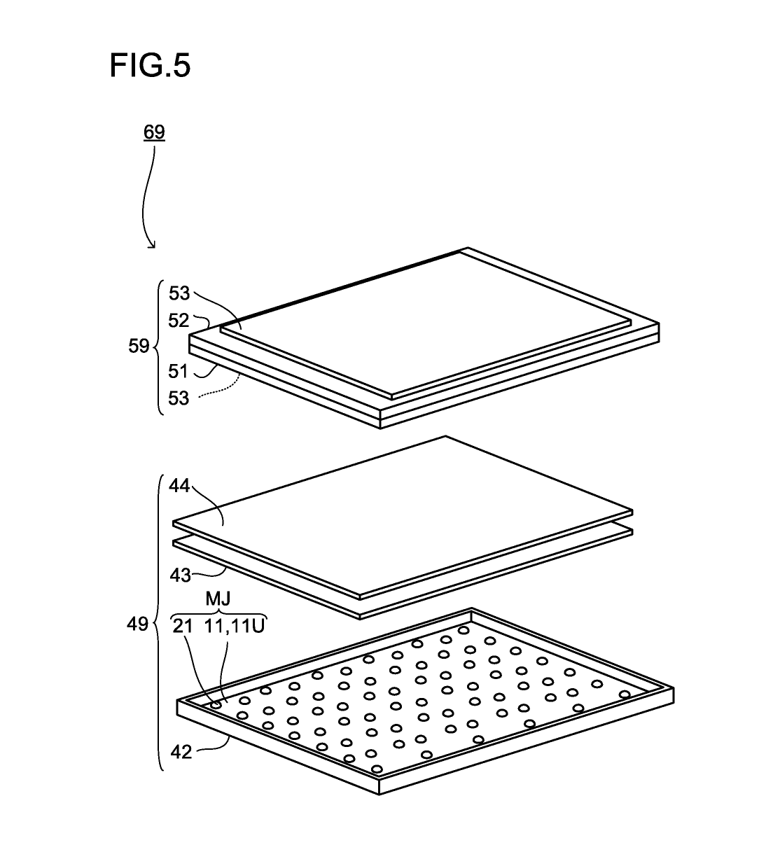

### BRIEF DESCRIPTION OF DRAWINGS

[FIG. 1] A plan view showing a mounting substrate of a backlight unit;

[FIG. 2] An enlarged plan view of the mounting substrate;

[FIG. 3] A plan view showing the mounting substrates connected to a power supply;

[FIG. 4] A perspective view showing display devices used in digital signage;

[FIG. 5] An exploded perspective view (which is a schematic view) when the display device is a liquid crystal display device; and

[FIG. 6] FIG. 6A is a cross-sectional view of a planar light source light emitting member that is included in a conventional backlight unit and that includes an LED; and FIG. 6B is a plan view showing a plurality of planar light source light emitting members arranged.

### BEST MODE FOR CARRYING OUT THE INVENTION

An embodiment will be described below with reference to accompanying drawings. For convenience, member symbols and the like may be omitted; in this case, other drawings should be referenced.

FIG. 4 is a perspective view showing an example of digital signage. Specifically, as shown in FIG. 4, display devices 69 that are attached to buildings BG along a road RD and a display device 69 that is arranged in front of the building BG function as the digital signage.

When the display device 69 is, for example, a liquid crystal display device, as shown in the schematic view of FIG. 5, the liquid crystal display device includes a liquid crystal display panel (display panel) 59 and a backlight unit (illumination device) 49 that supplies light to the liquid crystal display panel 59.

In the liquid crystal display panel 59, an active matrix substrate 51 that includes switching elements such as TFTs (thin film transistors) and an opposite substrate 52 opposite the active matrix substrate 51 are adhered with a sealant (not shown). Liquid crystal (not shown) is injected into a gap between both subtracts 51 and 52.

A polarization film 53 is attached to the light receiving surface side of the active matrix substrate 51 and the emission side of the opposite substrate 52. In the liquid crystal display panel 59 described above, variations in transmittance resulting from the inclination of the liquid crystal molecules are utilized, and thus an image is displayed.

The backlight unit 49 arranged directly below the liquid crystal display panel 59 will now be described. The backlight unit 49 includes LED modules (light emitting modules) MJ, a diffusion plate 43 and a brightness enhancement film 44 (a housing that holds these components is referred to as a backlight chassis 42).

The LED module MJ includes an LED (light emitting diode) 21 that serves as a point light source and that is a light emitting element and a mounting substrate 11 on which they are mounted. These will be described in detail later.

The diffusion plate (diffusion member) 43 is a plate-shaped optical member that is placed on the substrate surface 11U (the mounting surface 11U of the mounting substrate 11) over which the LEDs 21 are arranged; the diffusion plate 43 receives light emitted from the LED modules MJ to diffuse the light. In other words, the diffusion plate 43 diffuses planar light formed by a plurality of LED modules MJ, and spreads the light over the entire liquid crystal display panel 59.

The brightness enhancement film (brightness enhancement member) 44 is, for example, an optical member that has prism shapes within the sheet plane and that changes the characteristic of radiation of light; the brightness enhancement film 44 is arranged to cover the diffusion plate 43. Hence, the brightness enhancement film 44 collects the light that travels from the diffusion plate 43 and enhances the brightness.

The backlight unit 49 described above passes the planar light (backlight) formed by the LED modules MJ through a plurality of optical members 43 and 44, and supplies it to the liquid crystal display panel 59. In this way, the non-light emission liquid crystal display panel 59 receives the backlight from the backlight unit 49 and enhances the display function.

The LED module MJ will now be described in detail with reference to FIG. 1. FIG. 1 is a plan view mainly showing the LED modules MJ of the backlight unit 49. As shown in this figure, the LEDs 21 are placed over the backlight unit 49 (for convenience, in FIG. 1, connectors 35 and the like, which will be described later, are omitted).

Specifically, the LEDs 21 are mounted on the mounting substrates 11. The mounting substrate 11 is hexagonal; for example, as shown in FIG. 2, the shape thereof is a regular hexagon. A plurality of mounting substrates 11 of regular hexagons are arranged close to each other, and thus there is no gap between them (the method of connecting the mounting substrates 11 is not particularly limited; for example, they may be connected with an adhesive or with a fixing unit). A plurality of regular hexagonal mounting substrates 11 are arranged close to each other, and thus a large mounting substrate 11 having a honeycomb structure is formed (a member in which the mounting substrates 11 are arranged close to each other is referred to as a mounting substrate unit 13).

In this configuration, when at least one mounting substrate 11 is moved in a plurality of directions (for example, X-direction, Y-direction and Z-direction that are directions along the individual sides of the regular hexagonal mounting substrate 11 shown in FIG. 1) intersecting each other in the substrate surface, the mounting substrate 11 makes contact with other adjacent mounting substrates 11 and thus is prevented from being moved. Hence, in the planar direction (in short, in all the directions of the substrate surface) of the substrate surface of the large mounting substrate 11, the mounting substrates 11 are unlikely to be displaced from each other.

In general, when regular tetragonal (square) mounting substrates are arranged close to each other in a lattice, and thus a large mounting substrate is formed, if one substrate is moved along two directions in which the mounting substrates are aligned and which are perpendicular to each other, other mounting substrates in contact with such a mounting substrate are also moved together.

However, when the regular hexagonal mounting substrates 11 are arranged close to each other to form the large mounting substrate 11 having a honeycomb structure as shown in FIG. 1, even if one mounting substrate 11 is moved in two directions which are perpendicular to each other, the other mounting substrates 11 engage with such a mounting substrate 11 so as to prevent the movement of the mounting substrate 11. Hence, a group of a plurality of mounting substrates 11 is prevented from being displaced with respect to the remaining mounting substrates 11. In other words, in the backlight unit 49 described above, the mounting substrates 11 are stably arranged without being displaced (in short, the strength of the mounting substrate unit 13 is increased).

It can be said that the mounting substrates 11 shown in FIG. 1 are shaped such that they can engage with each other as a whole. In other words, the regular hexagonal mounting substrate 11 does not have special engagement portions, for example, projections and recesses that are provided in part of the perimeter of the mounting substrate and that allow engagement. Hence, extra portions (for example, projection and recess portions shown in FIG. 6B) are removed from the mounting substrate 11, and the size of the large mounting substrate 11 is relatively reduced accordingly.

The shape formed by arranging a plurality of mounting substrates 11 close to each other can be a shape other than a rectangle. Hence, the mounting substrate unit 13 described above can be suitable for various backlight units 49.

Incidentally, as shown in FIG. 2, the LED 21 has an anode (positive pole) 31 and a cathode (negative pole) 32. The anode 31 and the cathode 32 are connected, through wiring 33 (33A and 33B), to the connectors 35. This connector 35 includes three aligned terminals 36 (36B, 36A and 36B). In the three aligned terminals 36, the terminal 36 in the center is a positive terminal 36A, and terminals 36 at both ends are negative terminals 36B (the wiring electrically connecting the anode 31 and the positive terminals 36A is represented by 33A; the wiring electrically connecting the cathode 32 and the negative terminals 36B is represented by 33B).

The connectors 35, each of which includes the positive terminal 36A electrically continuous to the anode 31 of the LED 21 and the negative terminals 36B electrically continuous to the cathode 32 of the LED 21, are attached to the perimeter of the mounting substrate 11; the connectors 35 of the adjacent mounting substrates 11 are electrically continuous to each other. Specifically, when a plurality of mounting substrates 11 are arranged close to each other so as to have a honeycomb structure, the connectors 35 are arranged such that opposite connectors 35 (specifically, the terminals of like poles (positive or negative)) face each other and that they can be physically and electrically connected to each other.

In this configuration, as shown in FIG. 3, the positive power supply terminal 71A of a power supply 71 and the negative power supply terminal 71B of the power supply 71 are electrically connected through wiring 72 to the positive terminal 36A of the connector 35 and the negative terminal 36B of the connector 35, respectively, and thus the LEDs 21 are connected in parallel and can receive current. In other words, in the large mounting substrate 11, the circuit configuration for power supply is simplified. Even if the power supply 71 is connected to any of the connectors 35, current is supplied to all the LEDs 21.

### OTHER EMBODIMENTS

The present invention is not limited to the embodiment described above; various modifications are possible without departing from the spirit of the present invention.

For example, although, in the embodiment described above, one LED 21 is mounted on each of the mounting substrates 11, the present invention is not limited to this configuration. For example, a plurality of LEDs 21 may be mounted on each of the mounting substrate 11 (in short, at least one LED 21 is preferably arranged on the mounting substrate 11). When the mounting substrate 11 on which a plurality of LEDs 21 are mounted is used, the degree to which the LEDs 21 are arranged close to each other in the backlight unit 49 (the density of distribution) is changed as appropriate.

For example, since the lines of sight of a person are likely to be collected in the center of the liquid crystal display panel, the center may be made brighter than the other portions of the liquid crystal display panel. In this case, when the mounting substrate 11 on which a plurality of LEDs 21 are mounted is used, the LEDs 21 can be arranged closer to each other in the vicinity of the center of the mounting substrate unit 13 corresponding to the center of the liquid crystal display panel than in the other portions.

Although, in the embodiment described above, the display device 69 attached to the building has been described as the example of the digital signage, the present invention is not limited to this configuration. For example, even the display device 69 attached to a wall surface within a train can be said to be digital signage. Needless to say, the backlight unit 49 described above can be used not only as digital signage but also as a liquid crystal display device used mainly in a household.

The light emission color of the LED 21 is not particularly limited. For example, red light emitting LEDs 21, green light emitting LEDs 21 and blue light emitting LEDs 21 are arranged in the backlight unit 49 so as to be mixed. By mixing colors, white light may be produced, or the light of another color (single color light or mixed color light) may be produced. In short, the backlight unit 49 may be a full-color light emitting device (light source device). Needless to say, all the LEDs 21 may be white light emitting LEDs 21.

A predetermined amount of power is preferably supplied to the LEDs 21 without variations in power. Hence, for example, the LEDs 21 are connected to an unillustrated power supply adjustment device (power adjustment portion) incorporated in the backlight unit 49.

### LIST OF REFERENCE SYMBOLS

11 mounting substrate

13 mounting substrate unit

21 LED (point light source, light emitting element)

31 anode (positive pole)

32 cathode (negative pole)

33 wiring

35 connector

36 terminal

36A positive terminal

36B negative terminal

43 diffusion plate (diffusion member)

44 brightness enhancement film (brightness enhancement member)

49 backlight unit

69 display device

71 power supply

72 wiring

1. An illumination device that includes light sources and a plurality of mounting substrates having the light sources arranged,
wherein the mounting substrates are arranged close to each other, and the mounting substrates are regular hexagonal.

2. The illumination device of claim 1,
wherein connectors, each including a positive terminal electrically continuous to a positive pole of one of the light sources and a negative terminal electrically continuous to a negative pole of the light source, are attached to a perimeter of one of the mounting substrates, and
the terminals of like poles of the connectors in the adjacent mounting substrates are electrically continuous.

3. The illumination device of claim 1,
wherein the light source is a light emitting element.

4. The illumination device of claim 3,
wherein, as a plurality of the light emitting elements, a red light emitting element, a green light emitting element and a blue light emitting elements are provided so as to be mixed.

5. The illumination device of claim 3,
wherein a plurality of the light emitting elements are white light emitting elements.

6. The illumination device of claim 1, further comprising:
an electric power adjustment portion that adjusts an amount of power supplied to the light sources.

7. The illumination device of claim 1, further comprising:
a diffusion member that diffuses light from the light sources.

8. The illumination device of claim 1, further comprising:
a brightness enhancement member that enhances brightness by transmitting the light from the light sources.

9. A display device comprising:
the illumination device of claim 1; and
a display panel that receives light from the illumination device.

10. The display device of claim 9,
wherein the display panel is a liquid crystal display panel.
